(19) United States
(12) Patent Application Publication
(10) Pub. No.: US 2013/0120214 A1
(43) Pub. Date: May 16, 2013

(54) ANTENNA STRUCTURE

(71) Applicant: Wistron NeWeb Corporation, Hsinchu (TW)

(72) Inventor: Kuan-Hsueh Tseng, Hsinchu (TW)

(73) Assignee: WISTRON NEWEB CORPORATION, Hsinchu (TW)

(21) Appl. No.: 13/735,045

(22) Filed: Jan. 7, 2013

Related U.S. Application Data
(62) Division of application No. 12/752,141, filed on Apr. 1, 2010.

(30) Foreign Application Priority Data
Jan. 7, 2010 (TW) 099200248

(51) Int. Cl. H01Q 1/38; H01Q 1/48

(52) U.S. Cl. CPC H01Q 1/38; H01Q 1/48
USPC 343/846; 343/700 MS

(57) ABSTRACT

An antenna structure includes a radiation element, a grounding element, a short element, and a feeding element. The radiation element includes a first radiator and a second radiator, wherein the second radiator is extended from the first radiator and coupled to the first radiator. The short element includes a first end as well as a second end, wherein the first end of the short element is coupled to a joint in between the first radiator and the second radiator, and the second end of the short element is coupled to the grounding element. The feeding element includes a first end and a second end, and the first end of the feeding element is electrically connected with the radiation element. The short element is located on a first plane, and the feeding element is located on a second plane being different from the first plane.

### CROSS REFERENCE TO RELATED APPLICATIONS

This divisional application claims the benefit of co-pending U.S. patent application Ser. No. 12/752,141, filed on Apr. 1, 2010 and included herein by reference.

### BACKGROUND OF THE INVENTION

1. Field of the Invention

The present invention relates to an antenna structure, and more particularly, to an antenna structure making use of a short element and a feeding element, which are independent and located on different planes, to generate two individual currents with the same direction, such that radiation patterns and antenna efficiency of the antenna structure can be improved.

2. Description of the Prior Art

As wireless telecommunication develops with the trend of micro-sized mobile communication products, the location and the space arranged for antennas are limited. Therefore, some built-in micro antennas have been developed. Currently, micro antennas such as chip antennas, planar antennas etc are commonly used. All these antennas have the feature of small volume. The planar antenna has the advantages of small size, light weight, ease of manufacturing, low cost, high reliability, and can also be attached to the surface of any object. Therefore, micro-strip antennas and printed antennas are widely used in wireless communication systems.

Please refer to FIG. 1. FIG. 1 is a diagram of a conventional planner inverted F antenna (PIFA) 100 according to the prior art. The conventional PIFA 100 includes a radiation element 3, a grounding element 4, a conductive pin 5, and a feeding signal source 6. The radiation element 3 includes a first radiator 31 and a second radiator 32 for resonating at a first operating frequency band (with a higher frequency) and a second operating frequency band (with a lower frequency), respectively. The conductive pin 5 is disposed between the radiation element 3 and the grounding element 4, and has a first segment 51, a second segment 52 as well as a third segment 53 so as to form at least one bend 54 and 55. A first end 511 of the conductive pin 5 is connected to a joint in between the first radiator 31 and the second radiator 32, and a second end 522 of the conductive pin 5 is connected to the grounding element 4. Furthermore, a feeding signal source 6 is used for arousing the conventional PIFA 100. Herein a positive signal terminal of the feeding signal source 6 is coupled to the bend 54 formed by the first segment 51 and the second segment 52 of the conductive pin 5, that is to say, the bend 54 serves as the signal feeding point; while a negative signal terminal of the feeding signal source 6 is coupled to the grounding element 4. As can be known from FIG. 1, the conventional PIFA 100 directly feeds the signal into the conductive pin 5. In other words, only a single conductive pin 5 is used for achieving both the feeding function and the earthing function. Hence, no matter high frequency or low frequency is considered, only a single current I (with an insufficient current value) flows through the conductive pin 5, which may result in an insufficient bandwidth and a poor antenna efficiency.

Hence, how to improve antenna efficiency, adjust impedance matching, improve radiation patterns, and increase bandwidths of the antennas become important topics in this field.

### SUMMARY OF THE INVENTION

It is one of the objectives of the present invention to provide an antenna structure to solve the abovementioned problems.

According to an aspect of the present invention, an antenna structure is provided. The antenna structure includes a radiation element, a grounding element, a short element, and a feeding element. The radiation element includes a first radiator and a second radiator, wherein the second radiator is extended from the first radiator and coupled to the first radiator. The short element includes a first end as well as a second end, wherein the first end of the short element is coupled to a joint in between the first radiator and the second radiator, and the second end of the short element is coupled to the grounding element. The feeding element includes a first end and a second end, and the first end of the feeding element is electrically connected with the radiation element. The short element is located on a first plane, and the feeding element is located on a second plane being different from the first plane.

According to another aspect of the present invention, an antenna structure is provided. The antenna structure includes a substrate, a radiation element, a grounding element, a short element, and a feeding element. The substrate has a first plane and a second plane opposite to the first plane. The radiation element is located on the first plane and includes a first radiator as well as a second radiator. The first radiator is used for resonating at a first operating frequency band corresponding to a first resonance mode. The second radiator is used for resonating at a second operating frequency band corresponding to a second resonance mode, wherein a first end of the second radiator is extended from a first end of the first radiator. The grounding element includes a first grounding sub-element located on the first plane as well as a second grounding sub-element located on the second plane. The short element is located on the first plane, wherein the short element is coupled between the first end of the first radiator and the first grounding sub-element. The feeding element is located on the second plane and electrically connected with the radiation element.

According to another aspect of the present invention, an antenna structure is provided. The antenna structure includes a substrate, a radiation element, a grounding element, a short element, and a feeding element. The substrate has a first plane and a second plane opposite to the first plane. The shot element is located on the first plane, wherein the short element includes at least a first segment and a second segment, the first segment as well as the second segment form a bend, the first segment is coupled to the radiation element, and the second segment is coupled to the grounding element. The feeding element is located on the second plane and electrically connected with the radiation element. A first current flowing through the first segment of the short element has the same direction as a second current flowing through the feeding element.

According to another aspect of the present invention, an antenna structure is provided. The antenna structure includes a grounding element, a radiation element, a short element, and a feeding element. The radiation element includes a first radiator as well as a second radiator, wherein the second radiator is extended from the first radiator and coupled to the first radiator. The short element is coupled between a joint in between the first radiator as well as the second radiator and the grounding element. The feeding element is electrically connected with the radiation element. The radiation element and the short element are located on a first plane, the feeding element is located on a second plane being different from the first plane, and the grounding element is located on a third plane being different from the first plane and the second plane.

According to another aspect of the present invention, an antenna structure is provided. The antenna structure includes a grounding element, a short element, a radiation element, and a feeding element. The radiation element includes a first radiator as well as a second radiator, wherein the second radiator is extended from the first radiator and coupled to the first radiator. A first current flowing through the short element has the same direction as a second current flowing through the feeding element. The grounding element, the short element, the radiation element, and the feeding element belong to different parts of an identical metal sheet, respectively. The grounding element, the short element, the radiation element, and the feeding element are sequentially surrounded and disposed so as to form a hollow space.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional planner inverted F antenna (PIFA) according to the prior art.

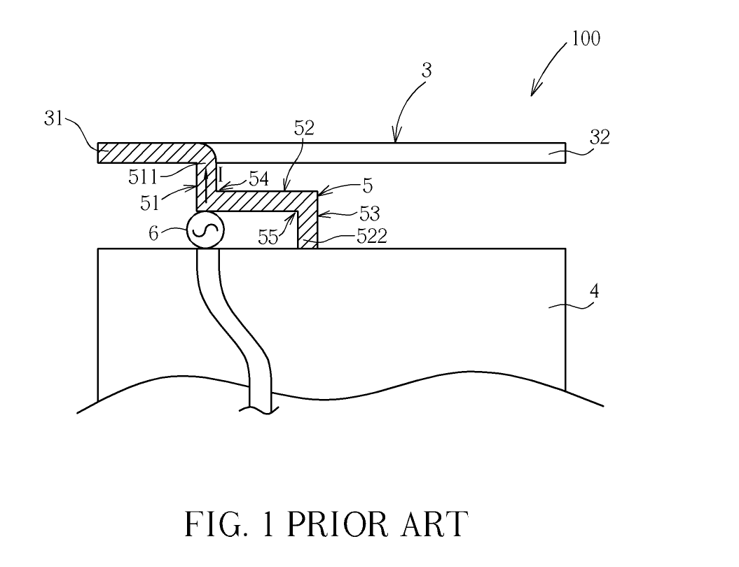

FIG. 2 is a diagram of an antenna structure according to a first embodiment of the present invention.

FIG. 3 (including 3A and 3B) shows a top view and a back view of the antenna structure shown in FIG. 2.

FIG. 4 is a diagram illustrating the VSWR of the antenna structure shown in FIG. 2.

FIG. 5 is a diagram illustrating the antenna efficiency of the antenna structure shown in FIG. 2.

FIG. 6 is a diagram of an antenna structure according to a second embodiment of the present invention.

FIG. 7 is a diagram of an antenna structure according to a third embodiment of the present invention.

FIG. 8 is a diagram of an antenna structure according to a fourth embodiment of the present invention.

FIG. 9 is a diagram of an antenna structure according to a fifth embodiment of the present invention.

FIG. 10 is a diagram of an antenna structure according to a sixth embodiment of the present invention.

FIG. 11 (including 11A and 11B) shows a top view and a back view of the antenna structure shown in FIG. 10.

### DETAILED DESCRIPTION

Be noted that in the embodiments thereinafter, the same components or similar components are denoted by using the same symbols or similar symbols in order to facilitate the description, and there is no need to give unnecessary details for the same description. The present invention is focused on improving the conventional PIFA, which makes uses of a short element and a feeding element located on different planes to generate two individual currents with the same direction in order to solve the abovementioned problems in the prior art.

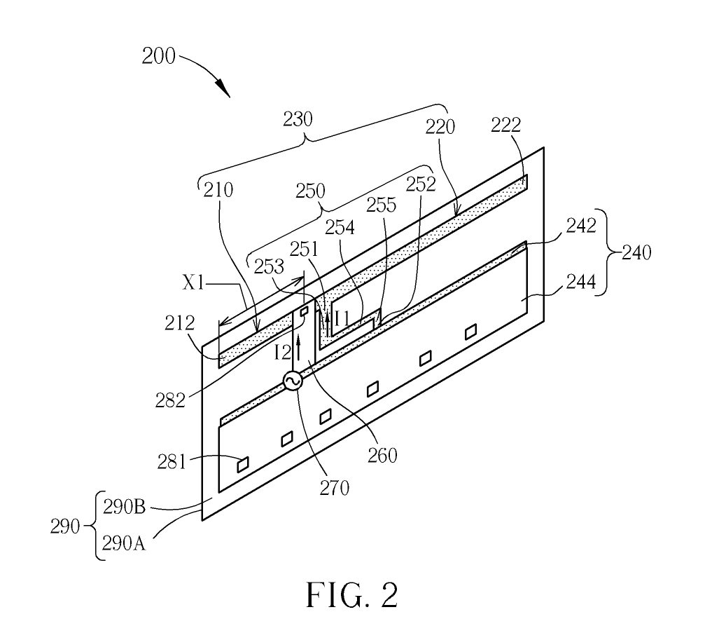

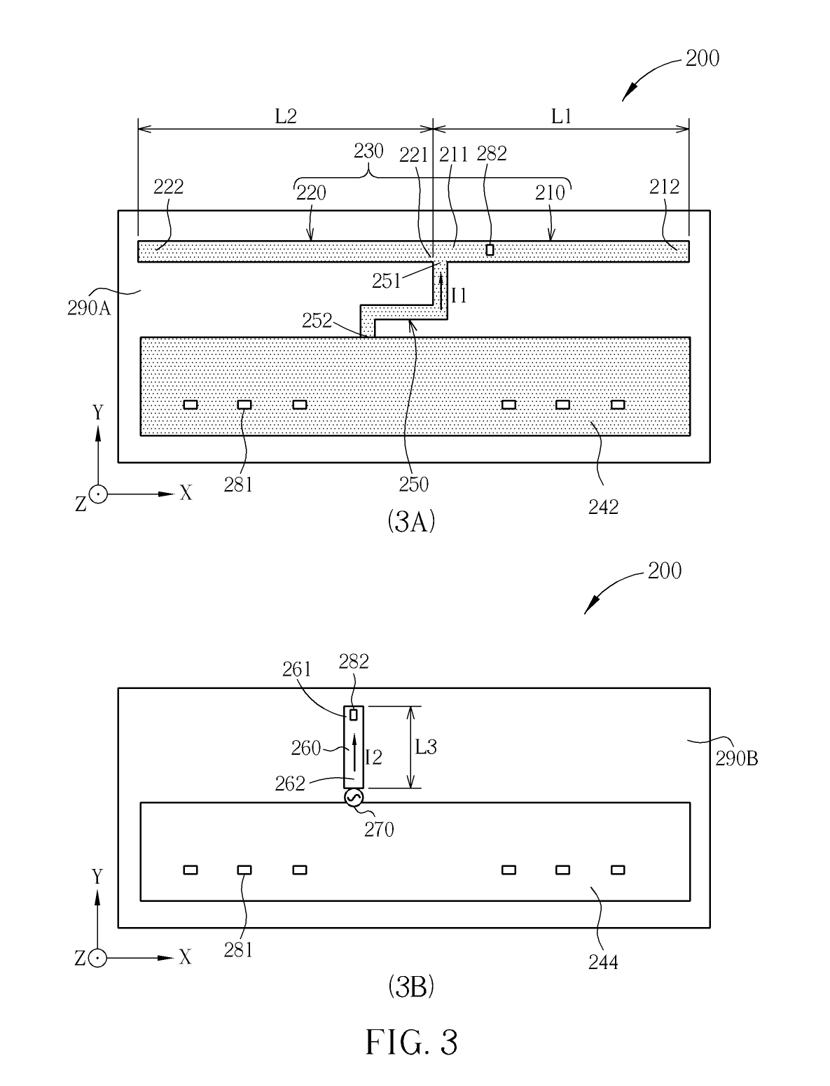

Please refer to FIG. 2 together with FIG. 3. FIG. 2 is a diagram of an antenna structure 200 according to a first embodiment of the present invention, and FIG. 3 (including 3A and 3B) shows a top view and a back view of the antenna structure 200 shown in FIG. 2. As FIG. 2 depicts, the antenna structure 200 includes, but is not limited to, a radiation element 230, a grounding element 240, a short element 250, a feeding element 260 and a substrate 290. The substrate 290 has a first plane 290A (as is also shown in 3A of FIG. 3) as well as a second plane 290B (as is also shown in 3B of FIG. 3) opposite to the first plane 290A. Additionally, the grounding element 240 includes a first grounding sub-element 242 and a second grounding sub-element 244, wherein the first grounding sub-element 242 is located on the first plane 290A (as is also shown in 3A), the second grounding sub-element 244 is located on the second plane 290B (as is also shown in 3B), and the first grounding sub-element 242 overlaps the second grounding sub-element 244.

As shown in 3A, the radiation element 230, the short element 250, and the first grounding sub-element 242 of the antenna structure 200 are located on the first plane 290A. The radiation element 230 has a first radiator 210 and a second radiator 220, wherein a first end 221 of the second radiator 220 is extended from a first end 211 of the first radiator 210. Be noted that the first radiator 210 resonates at a first operating frequency band corresponding to a first resonance mode (e.g., GSM-1800/1900 or WCDMA-2100), and the second radiator 220 resonates at a second operating frequency band corresponding to a second resonance mode (e.g., GSM-850/900). In addition, the short element 250 has a first end 251 and a second end 252, wherein the first end 251 is coupled to the joint in between the first radiator 210 and the second radiator 220, and the second end 252 is coupled to the first grounding sub-element 242.

As shown in 3B, the feeding element 260 and the second grounding sub-element 244 of the antenna structure 200 are located on the second plane 290B. The feeding element 260 has a first end 261 and a second end 262. Moreover, a feeding signal source 270 is disposed between the feeding element 260 and the second grounding sub-element 244, for arousing the antenna structure 200. Herein a positive signal terminal of the feeding signal source 270 is coupled to the second end 262 of the feeding element 260, and then the feeding element 260 is electrically connected with the radiator element 230 located on the first plane 290A through the second via hole 282; while a negative signal terminal of the feeding signal source 270 is coupled to the second grounding sub-element 244.

Please note that since the first grounding sub-element 242 and the second grounding sub-element 244 are individually located on different planes, while the feeding element 260 and the radiation element 230 are individually located on different planes, extra conducting components are required in order to electronically connect them with each other. In this embodiment, the antenna structure 200 further includes a first via hole 281 and a second via hole 282. The first via hole 281 is disposed in between the first grounding sub-element 242 and the second grounding sub-element 244 and passes through the first plane 290A and the second plane 290B of the substrate 290, for electrically connecting the first grounding sub-element 242 with the second grounding sub-element 244. However, the number of the first via hole 281 is not limited, or there is no need to additionally dispose the first via hole 281 in between the first grounding sub-element 242 and the second grounding sub-element 244. Similarly, the second via hole 282 is disposed in between the feeding element 260 and the radiation element 230 and passes through the first plane 290A and the second plane 290B of the substrate 290, for electrically connecting the feeding element 260 with the radiation element 230. Be noted that the number of the second via hole 282 is not limited.

What calls for special attention is that the short element 250 is used for electronically connecting the radiation element 230 with the grounding element 240 in order to adjust impedance matching. As a result, the style of the short element 250 can be adjusted depending on actual designs, and can have an arbitrary shape. That is to say, the short element 250 may include a plurality of segments to form at least one bend, but the number of the segments and the number of the bends are not limited. As FIG. 2 and FIG. 3 depict, the short element 250 includes a first segment 253, a second segment 254, and a third segment 255, wherein a first current I1 flowing through the first segment 253 of the short element 250 has the same direction as a second current I2 flowing through the feeding element 260, that is, each of them is a current flowing along the positive Y-axis direction. In other words, unlike the conventional PIFA 100 which directly feeds the signal into the short element, the antenna structure 200 disclosed in the present invention feeds the signal into the feeding element 260 first, and then the feeding element 260 is electronically connected with the radiation element 230 so as to achieve the goal of arousing the antenna. Therefore, these two individual currents I1 and I2 with the same direction can produce synergistic effects in the radiation patterns of the antenna, which can further improve antenna efficiency and increase the bandwidth of the antenna.

Please also note that the feeding element 260 may have an arbitrary shape, and its style can be adjusted depending on actual designs. In this embodiment, the feeding element 260 is implemented by a rectangle which only has one segment, but this should not be considered as limitations of the present invention. In other embodiments, the feeding element 260 may include a plurality of segments. As an illustration, the feeding element 260 may have a left extension segment extended to its left direction and a right extension segment extended to its right direction, respectively. Herein the left extension segment and the right extension segment are respectively located on positions corresponding to the first radiator 210 and the second radiator 220, and the left extension segment and the right extension segment (partially or completely) overlap the first radiator 210 and the second radiator 220, respectively. Those skilled in the art should appreciate that various modifications of the feeding element 260 may be made without departing from the spirit of the present invention, which also belongs to the scope of the present invention.

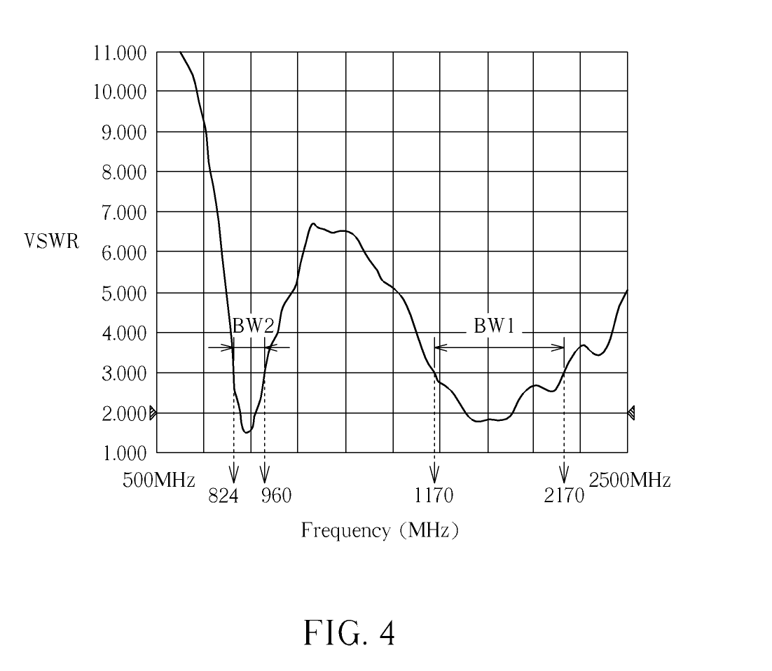

Please keep referring to FIG. 2 and FIG. 3. The first radiator 210 has a first length L1, the second radiator 220 has a second length L2 (as is shown in 3A), and the feeding element 260 has a third length L3 (as is shown in 3B). In this embodiment, the first radiator 210 is used for resonating at the first operating frequency band with a higher frequency, such as BW1 shown in FIG. 4. Hence, a sum of the first length L1 and the third length L3 is approximately one-fourth of a first wavelength corresponding to the first operating frequency band BW1, that is to say, L1+L3=λ¼. Additionally, the second radiator 220 is used for resonating at the second operating frequency band with a lower frequency, such as BW2 shown in FIG. 4. Hence, a sum of the second length L2 and the third length L3 is approximately one-fourth of a second wavelength corresponding to the second operating frequency band BW2, that is to say, L2+L3=λ 2/4.

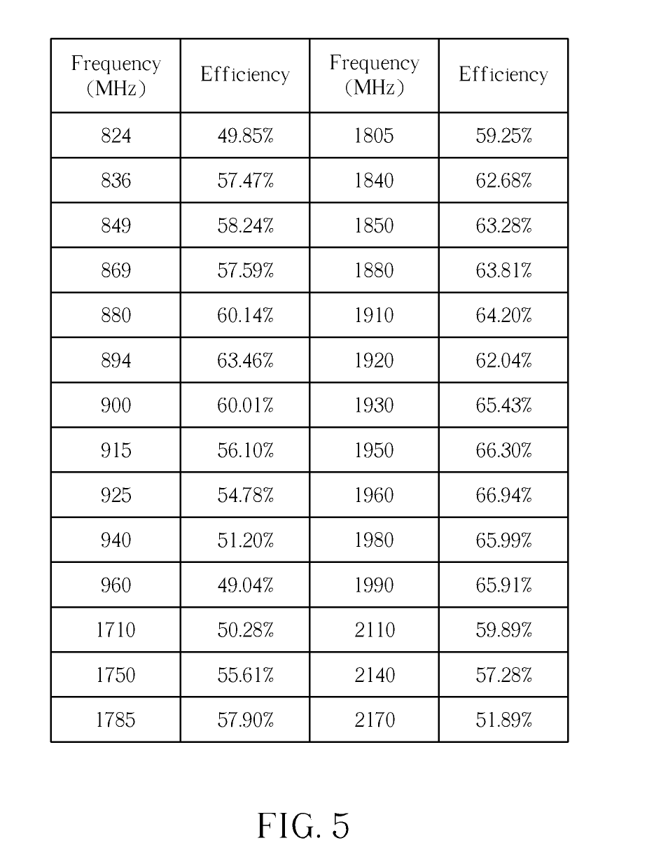

Please refer to FIG. 4 together with FIG. 5. FIG. 4 is a diagram illustrating the VSWR of the antenna structure 200 shown in FIG. 2, and FIG. 5 is a diagram illustrating the antenna efficiency of the antenna structure 200 shown in FIG. 2. In FIG. 4, The horizontal axis represents frequency (MHz), between 500 MHz and 2500 MHz, and the vertical axis represents the VSWR.

As shown in FIG. 4, the antenna structure 200 has a first resonance mode and a second resonance mode, wherein a first operating frequency band BW1 corresponding to the first resonance mode is from about 1710 MHz to 2170 MHz, and a second operating frequency band BW2 corresponding to the second resonance mode is from about 824 MHz to 960 MHz. As can be known from the measurement results shown in FIG. 5, the antenna efficiency of the antenna structure 200 is very good at all frequencies (including the first operating frequency band BW1 and the second operating frequency band BW2). In other words, no matter high frequency (i.e., BW1) or low frequency (i.e., BW2) is considered, both the short element 250 and the feeding element 260, which are individually located on different planes, can be used for generating the currents with the same direction in order to improve the antenna efficiency.

The antenna structure 200 shown in FIG. 2 is merely a practicable embodiment of the present invention, and various modifications of the antenna structure 200 may be made without departing from the spirit of the present invention. For example, in the abovementioned embodiment, a projection of the first end 261 of the feeding element 260 projected on the radiation element 230 (i.e., the X-axis coordinate of the feeding element 260) is located on the first radiator 210 of the radiation element 230 (as is shown in FIG. 2), but this in no way should be considered as limitations of the present invention. What calls for special attention is that the first end 261 of the feeding element 260 is at a designated distance X1 from the second end 212 of the first radiator 210 on a projection plane (i.e., the XY plane), and the antenna structure 200 has a better antenna efficiency when the designated distance X1 is in between one-eighth and one-sixth of the first wavelength (i.e., λ⅛<X1<λ⅙).

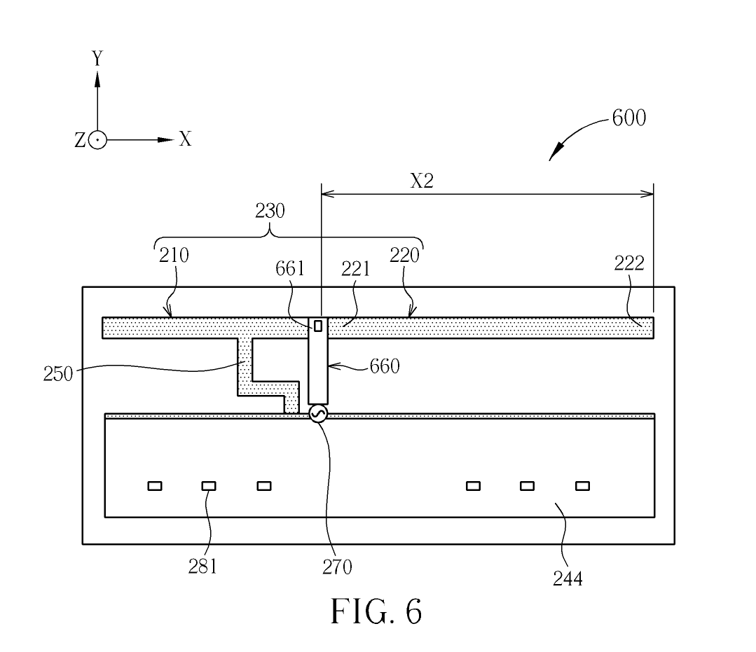

Please refer to FIG. 6. FIG. 6 is a diagram of an antenna structure 600 according to a second embodiment of the present invention. The architecture of the antenna structure 600 shown in FIG. 6 is similar to that of the antenna structure 200 shown in FIG. 2, and the difference between them is that the antenna structure 600 has a feeding element 660, wherein a projection of a first end 661 of the feeding element 660 projected on the radiation element 230 (i.e., the X-axis coordinate of the feeding element 660) is located at the second radiator 220 of the radiation element 230. What calls for special attention is that the first end 661 of the feeding element 660 is at a designated distance X2 from the second end 222 of the second radiator 220 on a projection plane (i.e., the XY plane), and the antenna structure 600 has a better antenna efficiency when the designated distance X2 is in between one-eighth and one-sixth of the second wavelength (i.e., λ 2/8<X2<λ 2/6).

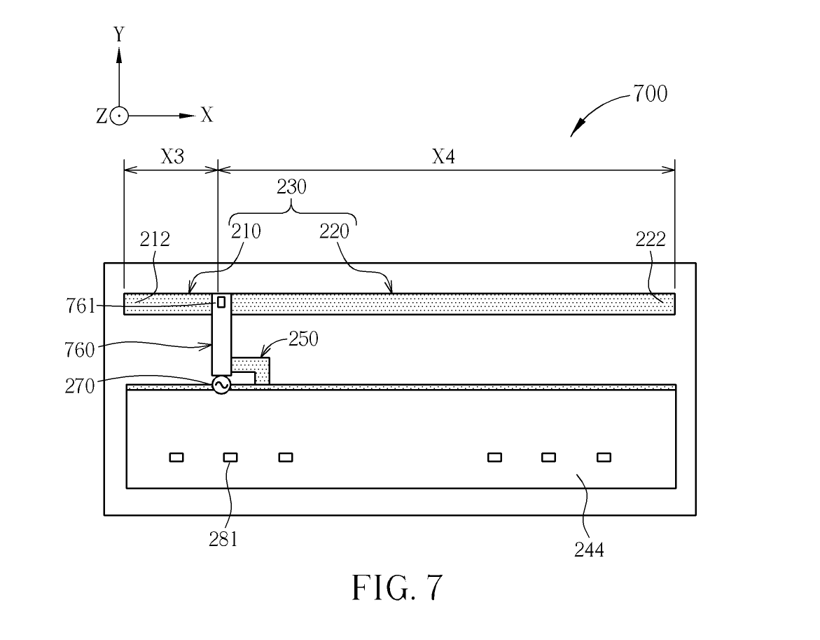

In the abovementioned embodiments, the short element 250 and the feeding element 260 or 660 are separately disposed on different positions of different planes, but the present invention is not limited to this only. In other embodiments, the short element 250 and the feeding element 260/660 can be disposed on the same position of different planes, which also belongs to the scope of the present invention. Please refer to FIG. 7. FIG. 7 is a diagram of an antenna structure 700 according to a third embodiment of the present invention. The architecture of the antenna structure 700 shown in FIG. 7 is similar to that of the antenna structure 200 shown in FIG. 2, and the difference is that the antenna structure 700 has a feeding element 760, wherein a projection of a first end 761 of the feeding element 760 projected on the radiation element 230 (i.e., the X-axis coordinate of the feeding element 760) is located at the joint in between the first radiator 210 and the second radiator 220.

What calls for special attention is that the first end 761 of the feeding element 760 is at a designated distance X3 from the second end 212 of the first radiator 210 on a projection plane (i.e., the XY plane), and the first end 761 of the feeding element 760 is at a designated distance X4 from the second end 222 of the second radiator 220 on the projection plane (i.e., the XY plane). Herein the antenna structure 700 has a better antenna efficiency when the designated distance X3 is in between one-eighth and one-sixth of the first wavelength (i.e., λ⅛<X3<λ⅙) or the designated distance X4 is in between one-eighth and one-sixth of the second wavelength (i.e., λ 2/8<X4<λ 2/6).

As can be known from the abovementioned embodiments, the projection of the first end of the feeding element projected on the radiation element 230 is not limited. Those skilled in the art should appreciate that various modifications to the location of the feeding element may be made without departing from the spirit of the present invention.

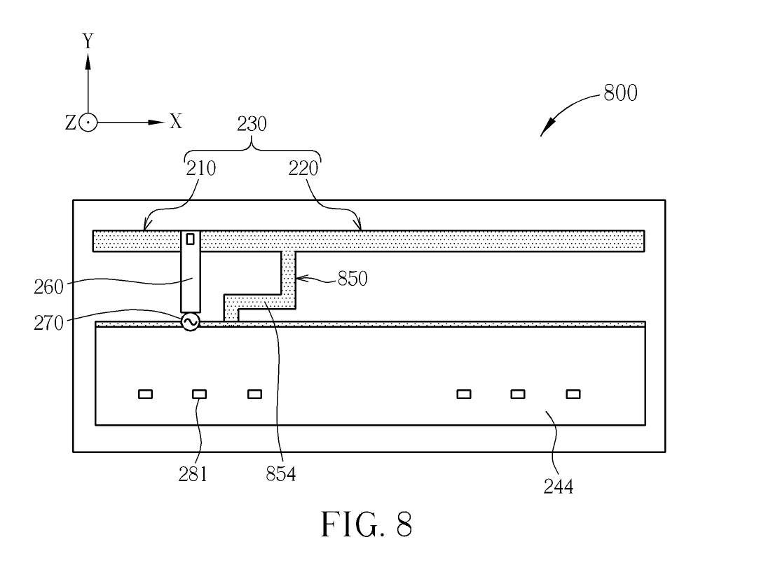

Please refer to FIG. 8. FIG. 8 is a diagram of an antenna structure 800 according to a fourth embodiment of the present invention. The architecture of the antenna structure 800 shown in FIG. 8 is similar to that of the antenna structure 200 shown in FIG. 2, and the difference between them is that the bending direction of the short element 850 of the antenna structure 800 (for example, its second segment 854 bends toward the negative X-axis) is different from the bending direction of the short element 250 of the antenna structure 200 (for example, its second segment 254 bends toward the positive X-axis).

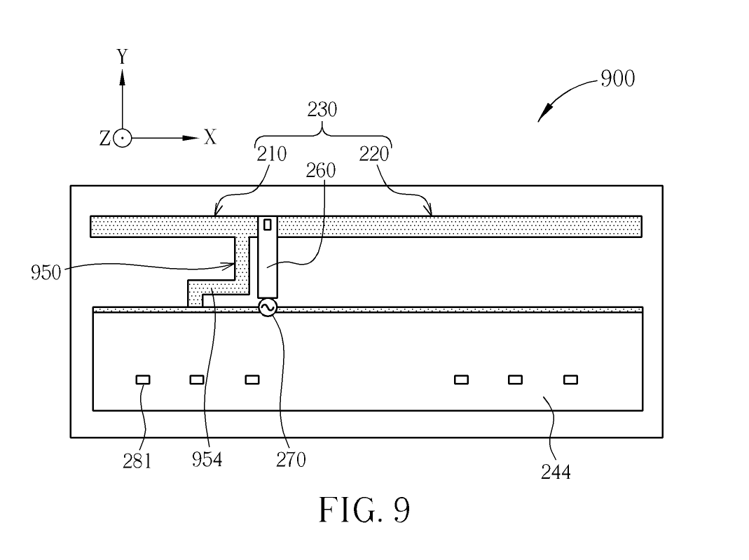

Please refer to FIG. 9. FIG. 9 is a diagram of an antenna structure 900 according to a fifth embodiment of the present invention. The architecture of the antenna structure 900 shown in FIG. 9 is similar to that of the antenna structure 600 shown in FIG. 6, and the difference between them is that the bending direction of the short element 950 of the antenna structure 900 (for example, its second segment 954 bends toward the negative X-axis) is different from the bending direction of the short element 250 of the antenna structure 600 (for example, its second segment 254 bends toward the positive X-axis).

In other words, the bending direction of the short element in no way should be considered as limitations of the present invention. Those skilled in the art should appreciate that various modifications to the bending direction of the short element may be made without departing from the spirit of the present invention.

In the embodiments above, a printed circuit board (PCB) is adopted for designing the antenna structures 200˜900 (e.g., the substrate 290), but the present invention is not limited to this only. In other embodiments, other materials or other means can be adopted for designing the antenna structure disclosed in the present invention.

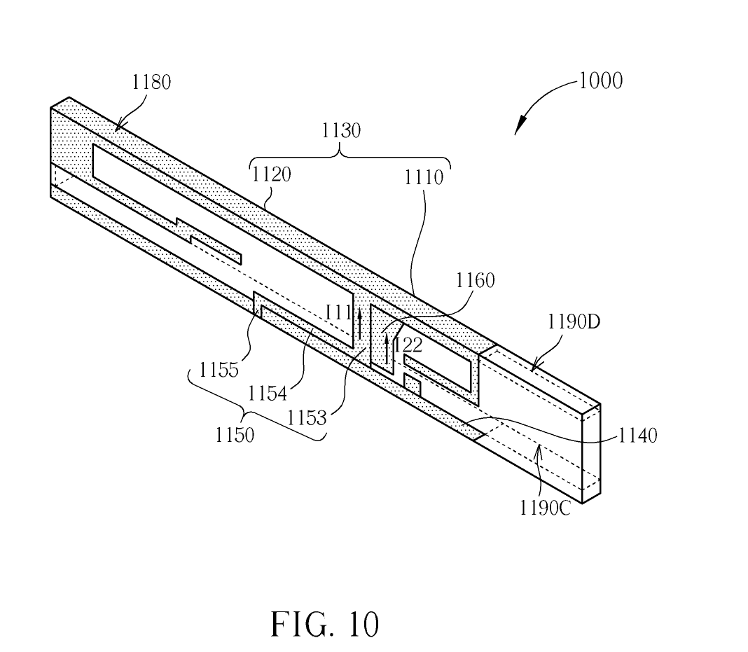

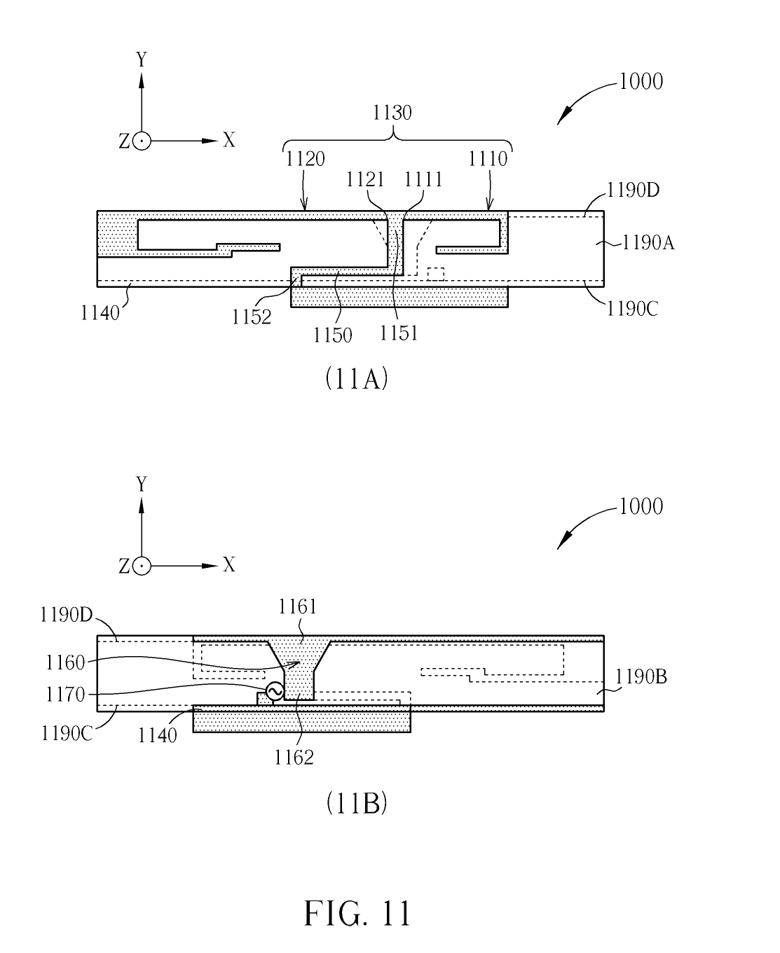

Please refer to FIG. 10 together with FIG. 11. FIG. 10 is a diagram of an antenna structure 1000 according to a sixth embodiment of the present invention, and FIG. 11 (including 11A and 11B) shows a top view and a back view of the antenna structure 1000 shown in FIG. 10. As shown in FIG. 10, the antenna structure 1000 includes a radiation element 1130, a short element 1150, a grounding element 1140, and a feeding element 1160. Herein the radiation element 1130 and the short element 1150 are located on a first plane 1190A, the feeding element 1160 is located on a second plane 1190B being different from the first plane 1190A, and the grounding element 1140 is located on a third plane 1190C being different from the first plane 1190A as well as the second plane 1190B. As an illustration, the first plane 1190A is substantially parallel to the second plane 1190B, and the third plane 1190C is substantially perpendicular to the first plane 1190A as well as the second plane 1190B.

As shown in 11A, the radiation element 1130 as well as the short element 1150 of the antenna structure 100 are located on the first plane 1190A. The radiation element 1130 includes a first radiator 1110 and a second radiator 1120, and a first end 1121 of the second radiator 1120 is extended from a first end 1111 of the first radiator 1110. Herein the first radiator 1110 is used for resonating at a first operating frequency band corresponding to a first resonance mode (e.g., GSM-1800/1900 or WCDMA-2100), and the second radiator 1120 is used for resonating at a second operating frequency band corresponding to a second resonance mode (e.g., GSM-850/900). In addition, the short element 1150 has a first end 1151 and a second end 1152, wherein the first end 1151 is coupled to the joint in between the first radiator 1110 and the second radiator 1120, and the second end 1152 is coupled to the grounding element 1140 (as is shown in FIG. 10).

As shown in 11B, the feeding element 1160 of the antenna structure 1000 is located on the second plane 1190B. The feeding element 1160 has a first end 1161 and a second end 1162. Moreover, a feeding signal source 1170 is disposed between the feeding element 1160 and the grounding element 1140, for arousing the antenna structure 1000. Herein a positive signal terminal of the feeding signal source 1170 is coupled to the second end 1162 of the feeding element 1160, and then the feeding element 1160 is electrically connected with the radiator element 1130 located on the first plane 1190A through the second feeding element 1180 (as is shown in FIG. 10); while a negative signal terminal of the feeding signal source 1170 is coupled to the grounding element 1140.

Please note that since the feeding element 1160 and the radiation element 1130 are individually located on different planes, extra conducting components are required in order to electronically connect them with each other. In this embodiment, the antenna structure 1000 further includes a second feeding element 1180, for electrically connecting the feeding element 1160 with the radiator element 1130. Herein the second feeding element 1180 is located on a fourth plane 1190D, and the fourth plane 1190D is substantially parallel to the third plane 1190C, that is to say, it is perpendicular to the first plane 1190A as well as the second plane 1190B.

Please also note that in this embodiment, the radiation element 1130, the short element 1150, the grounding element 1140, the feeding element 1160, and the second feeding element 1180 are an all-in-one design, and they belong to different parts of an identical metal sheet. Furthermore, the grounding element 1140, the short element 1150, the radiation element 1130, the second feeding element 1180 and the feeding element 1160 are sequentially surrounded and disposed so as to form a hollow space.

As FIG. 10 depicts, the short element 1150 has a first segment 1153, a second segment 1154, and a third segment 1155, and a first current Ill flowing through the first segment 1153 of the short element 1150 has the same direction as a second current 122 flowing through the feeding element 1160, that is, each of them is a current flowing along the positive Y-axis direction. In other words, unlike the conventional PIFA 100 which directly feeds the signal into the short element, the antenna structure 1000 disclosed in the present invention feeds the signal into the feeding element 1160 first, and then the feeding element 1160 is electronically connected with the radiation element 1130 through the second feeding element 1180 so as to achieve the goal of arousing the antenna structure 1000. Therefore, no matter high frequency or low frequency is considered, these two currents I11 and I22 with the same direction can produce synergistic effects in the radiation patterns of the antenna structure 1000, which can further improve antenna efficiency and increase the bandwidth of the antenna structure 100.

What calls for special attention is that the short element 1150 is used for electronically connecting the radiation element 1130 with the grounding element 1140 in order to adjust impedance matching of the antenna structure 1000. As a result, the style of the short element 1150 can be adjusted depending on actual designs, and may have an arbitrary shape. In addition, the bending direction of the short element 1150 in no way should be considered as limitations of the present invention. Those skilled in the art should appreciate that various modifications to the bending direction of the short element may be made without departing from the spirit of the present invention.

What's more, a projection of the first end 1161 of the feeding element 1160 projected on the radiation element 1130 is no limited. For example, it may be located on the first radiator 1110, on the second radiator 1120, or at the joint in between the first radiator 1110 and the second radiator 1120. Those skilled in the art should appreciate that various modifications to the X-axis coordinate of the feeding element 1160 may be made without departing from the spirit of the present invention.

The abovementioned embodiments are presented merely to illustrate practicable designs of the present invention, and in no way should be considered to be limitations of the scope of the present invention. Undoubtedly, those skilled in the art should appreciate that various modifications of the antenna structures 200˜1000 shown in FIG. 2-FIG. 10 may be made without departing from the spirit of the present invention. For example, the antenna structures shown in FIG. 2-FIG. 10 can be arranged or combined randomly into a new varied embodiment.

From the above descriptions, the present invention provides an antenna structure making use of a short element and a feeding element, which are independent and located on different planes, to generate two individual currents with the same direction. Therefore, no matter the antenna structure is operated under the low frequency or high frequency, synergistic effects can be produced in the radiation patterns of the antenna structure. As a result, antenna efficiency can be further improved, and the antenna bandwidth of the antenna structure can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna structure, comprising:
a radiation element, comprising:
a first radiator; and
a second radiator, wherein the second radiator is extended from the first radiator and coupled to the first radiator;
a grounding element;
a short element, having a first end as well as a second end, wherein the first end of the short element is coupled to a joint in between the first radiator and the second radiator, and the second end of the short element is coupled to the grounding element; and
a feeding element, having a first end as well as a second end, wherein the first end of the feeding element is electrically connected with the radiation element;
a substrate, having a first plane and a second plane; and
a first via hole, disposed in between the feeding element and the radiation element and passing through the first plane and the second plane of the substrate, for electrically connecting the feeding element with the radiation element;
wherein the short element is located on the first plane, and the feeding element is located on the second plane being different from the first plane.

2. The antenna structure of claim 1, wherein the grounding element comprises a first grounding sub-element and a second grounding sub-element, and the first grounding sub-element partially overlaps the second grounding sub-element; the first grounding sub-element is coupled to the second end of the short element, and the first grounding sub-element, the radiation element, as well as the short element are located on the first plane; and the second grounding sub-element is used for coupling a feeding signal source, and the second grounding sub-element as well as the feeding element are located on the second plane.

3. The antenna structure of claim 2, further comprising:
a second via hole, disposed in between the first grounding sub-element and the second grounding sub-element and passing through the first plane and the second plane of the substrate, for electrically connecting the first grounding sub-element with the second grounding sub-element.

4. An antenna structure, comprising:
a substrate, having a first plane and a second plane opposite to the first plane;
a radiation element, located on the first plane, the radiation element comprising:
a first radiator, for resonating at a first operating frequency band corresponding to a first resonance mode; and
a second radiator, for resonating at a second operating frequency band corresponding to a second resonance mode, wherein a first end of the second radiator is extended from a first end of the first radiator;
a grounding element, comprising a first grounding sub-element located on the first plane as well as a second grounding sub-element located on the second plane;
a short element, located on the first plane, wherein the short element is coupled between the first end of the first radiator and the first grounding sub-element; and
a feeding element, located on the second plane and electrically connected with the radiation element.

5. The antenna structure of claim 4, further comprising:
a first via hole, disposed in between the first grounding sub-element and the second grounding sub-element and passing through the first plane and the second plane of the substrate, for electrically connecting the first grounding sub-element with the second grounding sub-element; and
a second via hole, disposed in between the feeding element and the radiation element and passing through the first plane and the second plane of the substrate, for electrically connecting the feeding element with the radiation element.

6. The antenna structure of claim 4, wherein the short element at least comprises a first segment and a second segment, and the first segment as well as the second segment form a bend; and a first current flowing through the first segment of the short element has the same direction as a second current flowing through the feeding element.

7. An antenna structure, comprising:
a substrate, having a first plane and a second plane opposite to the first plane;
a radiation element;
a grounding element;
a shot element, located on the first plane, wherein the short element comprises at least a first segment and a second segment, the first segment as well as the second segment form a bend, the first segment is coupled to the radiation element, and the second segment is coupled to the grounding element; and
a feeding element, located on the second plane and electrically connected with the radiation element;
wherein a first current flowing through the first segment of the short element has the same direction as a second current flowing through the feeding element.
